(19) United States
(12) Patent Application Publication
(10) Pub. No.: US 2005/0110390 A1
(43) Pub. Date: May 26, 2005

(54) Flat panel display having spacers, method for manufacturing the spacers, and method for manufacturing the flat panel display

(76) Inventor: Kyung-Sun Ryu, Suwon-si (KR)

Correspondence Address: Robert E. Bushnell, Suite 300, 1522 K Street, N.W., Washington, DC, 20005, US

(21) Appl. No.: 10/934,704

(22) Filed: Sep. 7, 2004

(30) Foreign Application Priority Data
Nov. 26, 2003 (KR) 2003-84490

(51) Int. Cl. H01J 1/62; H01J 63/04; H01J 19/42

(52) U.S. Cl. 313/495; 313/292; 313/497

(57) ABSTRACT

A flat panel display having spacers, a method for manufacturing the spacers, and a method for manufacturing the flat panel display. The flat panel display includes a vacuum assembly that includes a first substrate and a second substrate. The first and second substrates are provided opposing one another with a predetermined gap therebetween, and a vacuum state is maintained in the gap between the first and second substrates. A plurality of spacers are mounted between the first substrate and the second substrate. Each of the spacers includes a main body section, and a buffer layer mounted on an end of the main body section opposing one of the first substrate and the second substrate (i.e., an opposing end). The buffer layer fills a space between the opposing end of the main body section of the spacer and the one of the first substrate and the second substrate closest to the opposing end of the main body section of the spacer.

### CLAIM OF PRIORITY

This application makes reference to, incorporates the same herein, and claims all benefits accruing under 35 U.S.C. §119 from an application for FLAT PANEL DISPLAY HAVING SPACERS, METHOD FOR MANUFACTURING THE SPACERS, AND METHOD FOR MANUFACTURING THE FLAT PANEL DISPLAY earlier filed in the Korean Intellectual Property Office on 26 Nov. 2003 and there duly assigned Serial No. 2003-84490.

### BACKGROUND OF THE INVENTION

1. Field of the Invention

The present invention relates to a flat panel display. More particularly, the present invention relates to a flat panel display having spacers, a method for manufacturing the spacers, and a method for manufacturing the flat panel display where the spacers are designed to fit properly and in the display.

2. Description of the Related Art

Unlike the cathode ray tube that is bulky and requires high voltages, the flat panel display has a thin profile and can be driven using low voltages. Examples of different types of flat panel displays include the FED (field emission display), VFD (vacuum fluorescent display), LCD (liquid crystal display), and PDP (plasma display panel).

The flat panel displays have significantly different structures and operate on equally different illumination principles depending on display type, examples of which have been listed above. Nevertheless, they all have some aspects in common such as the formation of a vacuum assembly by combining two substrates using a sealant and by evacuating the space between the two substrates. Most of the different types of flat panel displays also employ spacers that are mounted between the substrates to keep the two substrates spaced apart at a fixed distance.

The spacers enable the flat panel displays to withstand pressures applied thereto as a result of a difference between the internal, vacuum pressure and the external, atmospheric pressure. Also, the spacers serve to maintain a uniform distance between the two substrates. Spacers used in flat panel displays are typically made of glass or ceramic, and are generally formed in the shape of a column, bar, plus sign, or are cylindrical. The material and shape of the spacers are selected according to what best suits the particular characteristics of the flat panel display and the number of spacers used in the display system. The spacers used in flat panel displays are commonly produced by injection molding or a mechanical fabrication process.

One problem is that spacers, for a number of reasons, do not form a tight fit between the two substrates. If one spacer is longer than the rest, the remaining spacers may not form contact with the substrates and thus may not function properly. And the long spacer will be subjected to a lot of stress causing the spacer to crack and break. Also, such a configuration may cause the gap between the two substrates to vary across the display. Therefore, what is needed is a new design for spacers and a method of making the spacers and a method for making the display using the spacers such that all of the spacers equally function preventing spacers from breaking and maintaining a uniform distance between the substrates across the display.

### SUMMARY OF THE INVENTION

It is therefore an object of the present invention to provide an improved design for spacers used in a flat panel display.

It is also an object of the present invention to provide a method for making the spacers that is inexpensive and requires few process steps.

It is also an object of the present invention to provide a method for making a flat panel display using the novel spacers so that an equal amount of pressure is placed on each spacer used and the distance between the two substrates of the flat panel display is kept constant across the display.

These and other objects may be achieved by a flat panel display having spacers, a method for manufacturing the spacers, and a method for manufacturing the flat panel display, in which the spacers are made having the same height such that the spacers are prevented from cracking and undergoing other forms of physical destruction, thereby maintaining a uniform gap between substrates and preventing a reduction in picture quality.

In an exemplary embodiment of the present invention, a flat panel display includes a vacuum assembly including a first substrate and a second substrate provided opposing one another with a predetermined gap therebetween, a vacuum state being maintained between the first and second substrates, and a plurality of spacers mounted between the first substrate and the second substrate. Each of the spacers includes a main body section, and a buffer layer mounted on an end of the main body section opposing one of the first substrate and the second substrate, the buffer layer filling a space between this end of the main body section and the one of the first substrate and the second substrate.

The buffer layers have differing thicknesses for each of the spacers. Further, heights of the combinations of the main body sections and the buffer layers for each of the spacers are substantially identical. In addition, the buffer layers have substantially the same cross-sectional shape as the main body section, where the cross sections are taken along planes substantially parallel to the first and second substrates.

In another embodiment, a method for manufacturing spacers includes printing a paste on at least one end of main body sections of spacers, and forming height compensation layers by drying the paste. A thickness of the height compensation layers is 3-15% of an entire height of the spacers.

The forming height compensation layers includes printing a photosensitive paste on a substrate, and drying the paste to form a base layer that is formed into the height compensation layers, positioning the main body sections on the base layer, selectively exposing the base layer, that is, all areas of the base layer except areas covered by the main body sections, developing the substrate to remove exposed areas of the base layer, and removing the main body sections with remaining areas of the base layer attached thereto from the substrate.

The method further includes forming a lift-off metal layer formed over an entire surface of the substrate. This is performed prior to printing a photosensitive paste on a substrate. The method further includes performing wet etching of the lift-off metal layer following developing the substrate and prior to removing the main body sections.

In yet another embodiment, a method of manufacturing a flat panel display includes forming structures on a first substrate and a second substrate for realizing the display of images, producing spacers that includes main body sections, and height compensation layers formed on one end of the main body sections, positioning the spacers on the first substrate in predetermined non-pixel regions of the first substrate, positioning the first substrate and the second substrate in a state opposing one another with the spacers interposed therebetween, and applying pressure on the second substrate in a direction toward the first substrate to seal the first substrate to the second substrate, and, simultaneously, performing sintering such that the height compensation layers are melted so that any gaps between the spacers and the second substrate are filled by the height compensation layers.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a partial sectional view of a flat panel display, in which only select elements of the display are illustrated;

FIGS. 2 and 3 are partial sectional views of a flat panel display according to an exemplary embodiment of the present invention;

FIG. 4 is a partial sectional view of the flat panel display of FIGS. 2 and 3, in which only select elements of a vacuum assembly and spacers are illustrated; and

FIGS. 5-10B are partial sectional views of the flat panel display of FIGS. 2 and 3, in which only select elements are illustrated as they undergo sequential processes for manufacture.

### DETAILED DESCRIPTION OF THE INVENTION

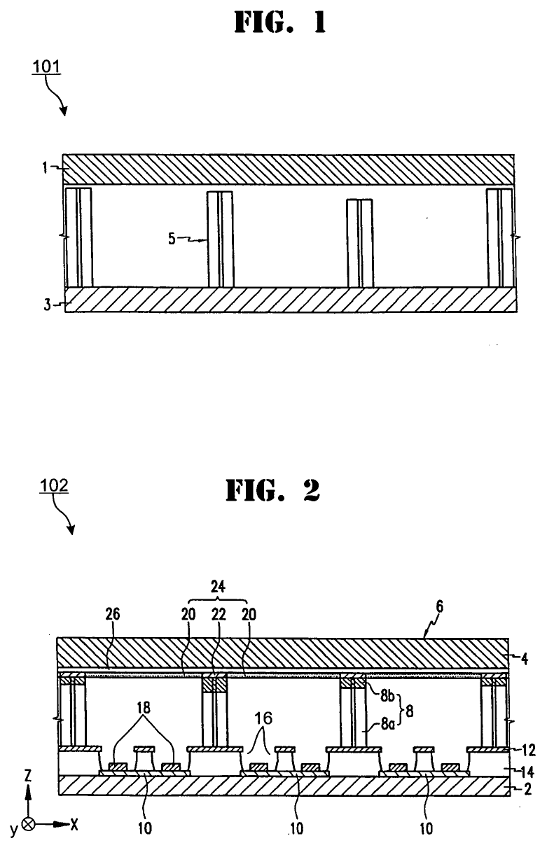

Turning now to FIG. 1, FIG. 1 illustrates a flat panel display 101 with spacers 5 between upper and lower substrates 1 and 3 respectively. A serious problem of spacers 5 in FIG. 1 is that their heights may not be uniform within the flat panel display. This is illustrated in FIG. 1, in which spacers 5 mounted between an upper substrate 1 and a lower substrate 3 have varying heights. Such a problem may be attributed to one or a combination of different factors, such as the spacers 5 themselves having different lengths, a paste (not illustrated) used to fix the spacers 5 to suitable locations being applied at different thicknesses, and structures (not illustrated) formed between the upper substrate 1 and the lower substrate 3 having varying heights.

A consequence of these problems in FIG. 1 is that pressures applied to the flat panel display 101 as described above are concentrated at the spacers 5 having the greatest heights. This may result in the physical breakdown of these spacers 5, thereby causing the gap between the upper and lower substrates 1 and 3 to become even more uneven and ultimately reducing picture quality.

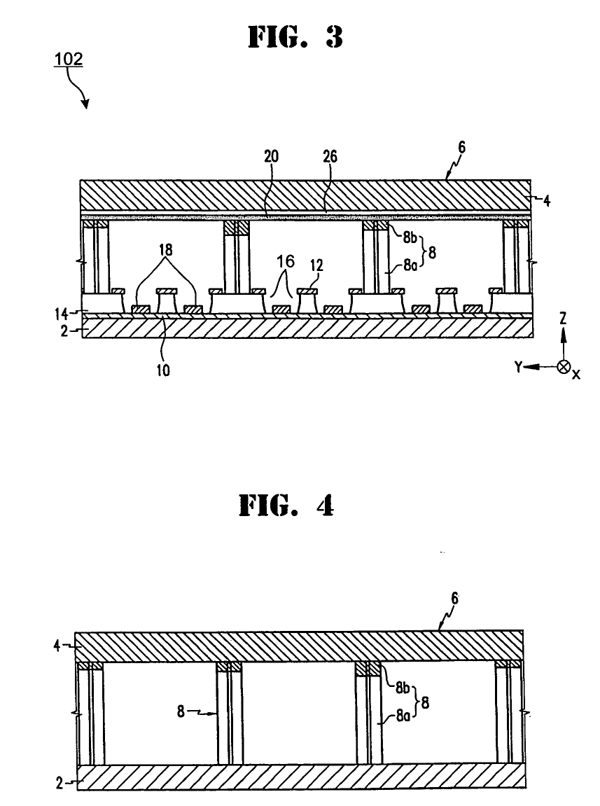

Turning now to FIGS. 2 and 3, FIGS. 2 and 3 are partial sectional views of a flat panel display 102 according to an exemplary embodiment of the present invention, and FIG. 4 is a partial sectional view of the flat panel display 102 of FIGS. 2 and 3, in which only select elements of a vacuum assembly and spacers are illustrated.

The flat panel display 102 includes a vacuum assembly 6. The vacuum assembly 6 is made up of a first substrate 2 and a second substrate 4 provided opposing one another with a predetermined gap therebetween, and a vacuum is formed in the gap between the first and second substrates 2 and 4. Further, a plurality of spacers 8 are mounted between the first and second substrates 2 and 4. The spacers 8 enable the flat panel display 102 to withstand pressures applied thereto resulting from a difference between an internal pressure and an external pressure.

FIGS. 2 and 3 illustrate the structure of a field emission display (FED), which is one example of the different types of flat panel displays. Although the present invention can also be applied to VFD, LCD and PDP displays, this specification will illustrate and describe how the present invention applies to a FED. FIG. 2 illustrates a cross section of the display 102 looking in the +y-direction and FIG. 3 illustrates the same display 102 but looking instead in the +x-direction. In the FED, formed on a surface of the first substrate 2 opposing the second substrate 4 are cathode electrodes 10, an insulation layer 14 formed on the cathode electrodes 10, and gate electrodes 12 formed on the insulation layer 14 such that the insulation layer 14 is interposed between the cathode electrodes 10 and the gate electrodes 12. The cathode electrodes 10 are formed in a striped pattern with long axes aligned along one direction (the +/−y-direction), and the gate electrodes 12 are also formed in a striped pattern with long axes aligned in a direction (+/−x-direction) substantially perpendicular to the direction of the long axes of the cathode electrodes 10.

Pixel regions are formed at areas where the cathode electrodes 10 intersect the gate electrodes 12. Apertures 16 are formed passing through the gate electrodes 12 and through the insulation layer 14 in the pixel regions. The apertures 16 expose the cathode electrodes 10. Further, an emitter 18 is formed in each of the apertures 16 on exposed regions of the cathode electrodes 10.

Formed on a surface of the second substrate 4 opposing the first substrate 2 is an anode electrode 26. A phosphor screen 24 that includes phosphor layers 20 and black layers 22 are formed either on a surface of the anode electrode 26 opposite a surface adjacent to the second substrate 4, or interposed between the anode electrode 26 and the second substrate 4. The anode electrode 26 is made of a transparent material such as ITO (indium tin oxide) to thereby enable the transmission of visible light therethrough, in which the visible light is generated by the excitation of the phosphor layers 20. A metal layer (not illustrated) may be formed covering the phosphor screen 24 to provide a metal back effect for enhancing screen brightness. If such a configuration is used, the metal layer may be used in place of the anode electrode 26 by applying a high positive voltage to the metal layer so that electrons emitted from the emitters 18 on the first substrate 2 are accelerated toward the second substrate 4.

By applying predetermined drive voltages to the cathode electrodes 10 and the gate electrodes 12, electric fields are formed in the vicinity of the emitters 18 by a voltage difference between the cathode electrodes 10 and the gate electrodes 12. This results in the emission of electrons from the emitters 18. Further, by applying a positive voltage to the anode electrode 26, the emitted electrons are attracted (i.e., accelerated) toward the second substrate 4 to thereby strike the phosphor layers 20. This excites the phosphor layers 20 so that they illuminate. Such an operation is selectively performed to realize the display of images.

In the illustrated embodiment, spacers 8 are mounted in non-pixel regions on the first substrate 2. It is to be appreciated that spacers 8 can instead be mounted on second substrate 4. The spacers 8 are formed to substantially equal lengths (heights) to thereby maintain a uniform, predetermined gap between the first substrate 2 and the second substrate 4. Spacers 8 extend in a +/−z-direction as illustrated in FIGS. 2 and 3. Each of the spacers 8 includes a main body section 8a and a buffer layer 8b. The buffer layer 8b of each of the spacers 8 is provided to make the total heights of the spacers 8 substantially equal, and buffer layer 8b is interposed between the main body section 8a and either the first substrate 2 or the second substrate 4, depending on which of these first and second substrates 2 and 4 the spacers 8 are mounted. For example, if the spacers 8 are mounted on the first substrate 2 as described above, the buffer layers 8b are interposed between the main body sections 8a and the second substrate 4. If the spacers 8 are instead mounted on the second substrate 4, the buffer layers will then between the main body sections 8a and the first substrate 2. It is to be appreciated that both embodiments, where the spacers are first mounted on first substrate 2 or first mounted on second substrate 4 are within the scope of the present invention, however, the case where the spacers are first mounted on first substrate 2 will be described.

The main body sections 8a of the spacers 8 are made of glass, ceramic, or photosensitive glass, and are formed in the shape of a column, bar, plus sign, or are cylindrical. The case where the main body sections 8a are formed in the shape of a plus sign (when viewed along the +/−z-direction) is illustrated. The main body sections 8a may have differences in length as a result of variations occurring during manufacture. The buffer layers 8b are formed in the same shape as the main body sections 8a. That is, in this case, the buffer layers 8b are formed in the shape of a plus sign when viewed along the +/−z-direction. The buffer layers 8b are made of a photosensitive material.

With the first substrate 2 and the second substrate 4 structured as described above, a sealant (not illustrated) is provided along opposing edges of the first and second substrates 2 and 4, then the second substrate 4 is pressed onto the first substrate 2 (or vice versa) in a high temperature environment to thereby seal the same. The high temperature applied at this time melts the buffer layers 8b of the spacers 8 to thereby fill any spaces between the main body sections 8a of the spacers 8 and the second substrate 4 (when the spacers 8 are first mounted on the first substrate 2). Therefore, the buffer layers 8b act to compensate for any differences in heights of the main body sections 8a, thereby making the overall heights of the spacers 8 substantially identical.

The end result is that all the spacers 8 receive substantially the same amount of pressure so that the likelihood of physical breakdown of the any one spacer is significantly reduced. Also, the gap between the first substrate 2 and the second substrate 4 is uniformly maintained across the display so that picture quality is enhanced.

Although the FED illustrated in FIGS. 2 and 3 gives the impression that the spacers 8 are mounted in each of the non-pixel regions for all the rows of the cathode electrodes 10 and for all the rows of the gate electrodes 12, the spacers 8 may instead be selectively formed between specific rows of the cathode electrodes 10 and the gate electrodes 12, and in specific non-pixel regions and not in every single non-pixel region.

The FED is given as an example of a flat panel display in the above. However, the exemplary embodiment of the present invention may also be applied to other flat panel display configurations such as the VFD (vacuum fluorescent display), LCD (liquid crystal display), and PDP (plasma display panel).

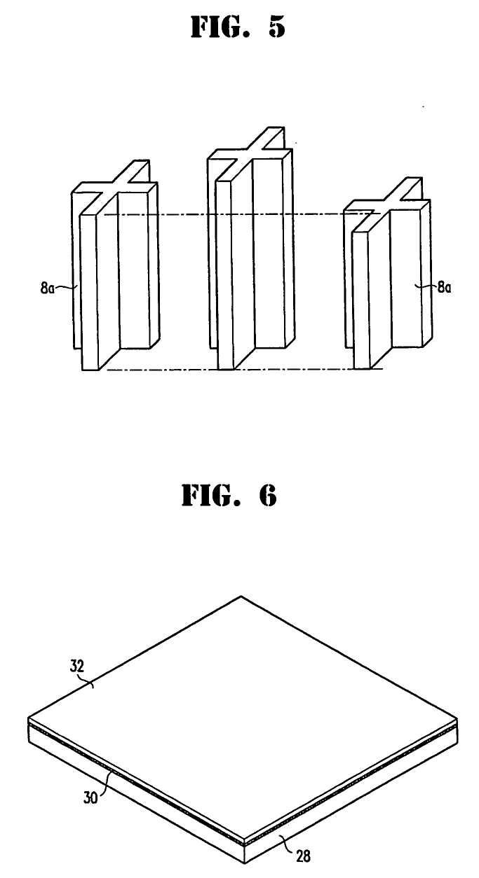

Turning now to the remaining figures, FIGS. 5-10B are partial sectional views of the flat panel display 102 of FIGS. 2 and 3, in which only select elements are illustrated as they undergo sequential processes for manufacture.

A structure is first formed between the first substrate 2 and the second substrate 4 to realize the display of images. For example, in the case where the flat panel display is an FED such as that illustrated in FIG. 2, the cathode electrodes 10, the insulation layer 14, the gate electrodes 12, and the emitters 18 are formed on the first substrate 2. Also, the phosphor screen 24 and the metal layer 26 are formed on the second substrate 4.

Subsequently, with reference to FIG. 5, the main body sections 8a of the spacers 8 are produced. The main body sections 8a are manufactured using injection molding or mechanical processes, and using either glass or ceramic. Alternatively, the main body sections 8a are manufactured to a desired shape using photosensitive glass, in which case exposure and developing are performed to obtain the main body sections 8a. As an example, the main body sections 8a illustrated are formed into the shape of a plus sign when viewed along a cross section of the main body sections 8a.

Differences in length of the main body sections 8a occur as a result of variations in the processes used to manufacture the same. Therefore, a height compensation layer 8c is formed on one end of each of the main body sections 8a. An example of a method to form the height compensation layers 8c is described with reference to FIGS. 6 through 9.

With reference first to FIG. 6, a substrate 28 is prepared, then a lift-off metal layer 30 is formed on the substrate 28. Next, a photosensitive paste is printed and dried on the lift-off metal layer 30 to form a base layer 32 for forming the height compensation layers 8c. In one embodiment, chromium (Cr) or aluminum (Al) is used for the lift-off metal layer 30. The base layer 32 later will become the height compensation layer 8c which will later become the buffer layer 8b of the spacers. The material for this base layer is preferably photosensitive, is malleable or melts when heat and pressure are applied, and can bind to another material. Also, a vacuum deposition process or sputtering process is used to form the lift-off metal layer 30 to a thickness of 500˜2000 Å.

Subsequently, with reference to FIG. 7, one end of the main body sections 8a is positioned on the base layer 32. Using a light source (not illustrated) positioned above the substrate 28 (on a side of the main body sections 8a opposite that adjacent to the base layer 32), ultraviolet rays are irradiated onto all elements to expose the base layer 32. The direction of the ultraviolet rays are indicated by the arrows in FIG. 7. During this process, areas of the base layer 32 covered by the main body sections 8a are prevented from being exposed, while all other areas of the base layer 32 are exposed. Thus, the main body sections 8a serve as a mask for the base layer 32 that serves as a layer of photosensitive material.

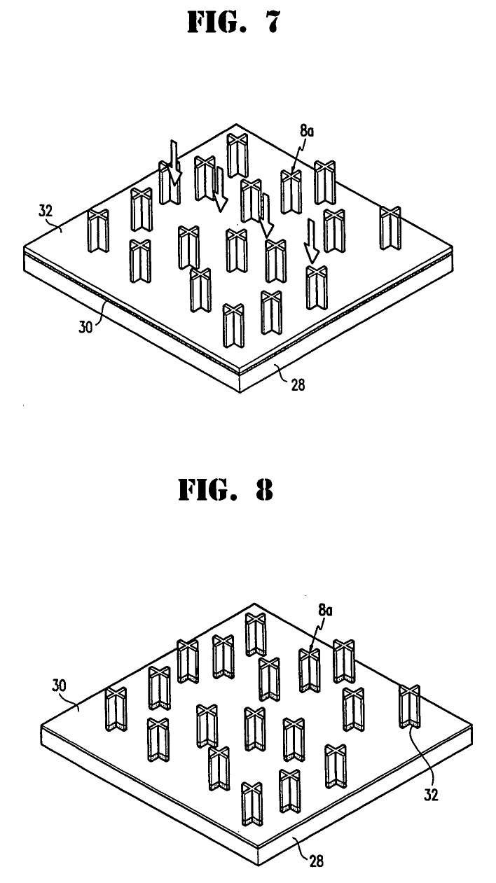

Next, the substrate 28 is developed such that exposed areas of the base layer 32 are selectively removed as illustrated in FIG. 8. This results in only areas of the base layer 32 corresponding to the location directly underneath the main body sections 8a remaining on the substrate 28.

In the above exposure and developing processes, therefore, the main body sections 8a act as exposure masks. This makes it unnecessary to use a separate mask and to perform alignment of such a mask. Hence, the processes are simplified as a result of being able to perform printing of a photosensitive paste over the entire surface of the substrate 28, and by the fact that a separate mask need not be used. Mass production is also significantly simplified. Thus, the exposure and the alignment are done in a single step, thus reducing processing steps which greatly reduces manufacturing costs. To improve the ability of the main body sections 8a to block ultraviolet rays, a metal layer (not illustrated) may be formed on ends of the main body sections 8a opposite the end mounted on the base layer 32. This enhances the patterning of the base layer 32.

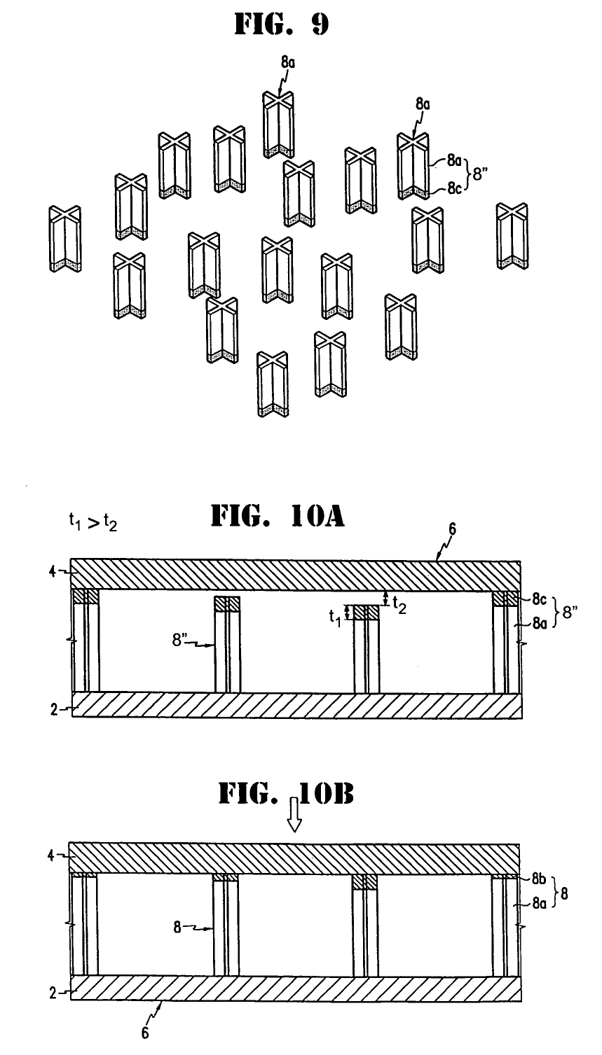

Following the above processes, with reference to FIG. 9, wet etching is performed using an etchant to remove the lift-off metal layer 30. This separates the uninstalled spacers 8″ from the substrate while keeping the height compensation layer 8c in tact and connected to main body sections 8a. After lift-off, the processing of the uninstalled spacers 8″ are completed. Each completed uninstalled spacer 8″ is made up of a main body section 8a and a height compensation layer 8c. Uninstalled spacer 8″ will become spacer 8 when height compensation layer 8c becomes a buffer layer 8b during the process for making the flat panel display to be later discussed. Uninstalled spacer 8″ has a different reference numeral than spacer 8 as uninstalled spacer 8″ is made up of parts that are slightly different than spacer 8, namely, the presence of height compensation layer 8c and the lack of buffer layer 8b.

These uninstalled spacers 8″ are then used when performing additional processes to complete the formation of the flat panel display 102. In particular, with reference to FIG. 10A, the uninstalled spacers 8″ are mounted in predetermined non-pixel regions on the first substrate 2. This is done with the main body sections 8a placed adjacent to the first substrate 2 and the height compensation layers 8c facing away from the first substrate 2. It is to be appreciated that the uninstalled spacers 8″ can be instead mounted on second substrate 4, but the scenario of where uninstalled spacers 8″ are mounted on the first substrate 2 will now be discussed. An adhesive paste (not illustrated), for example, is used to fix the uninstalled spacers 8″ on the insulation layer 14 of FIG. 2 (again in non-pixel regions). Next, a sealant (not illustrated) is formed around an edge of the first substrate 2 on a surface of the same opposing the second substrate 4. Then the second substrate 4 is positioned over the first substrate 2 until the second substrate 4 comes to be rested on the uninstalled spacers 8″.

The second substrate 4 may not contact all the uninstalled spacers 8″, particularly those uninstalled spacers 8″ with smaller heights. That is, with the second substrate 4 positioned on the first substrate 2 as illustrated in FIG. 10A, some of the uninstalled spacers 8″ closely contact the second substrate 4, while other uninstalled spacers 8″ have gaps t₂ of varying lengths with the second substrate 4.

Next, the first and second substrates 2 and 4 are sealed and sintered in a high temperature environment of approximately 450˜500° C. to thereby fully secure the first and second substrates 2 and 4 to one another. During this process, the height compensation layers 8c of the uninstalled spacers 8″ melt as a result of the high temperature, and by applying a predetermined pressure to the second substrate 4 in a direction toward the first substrate 2, the second substrate 4 is displaced downward such that the gaps between the second substrate 4 and specific spacers 8 are removed. Hence, the height compensation layers 8c take on a length as needed to remove the gaps t₂ such that the height compensation layers 8c are converted into the buffer layers 8b during this heat and pressure treatment. The downward pressure on the second substrate 4 also aids in providing a better seal between the first and second substrates 2 and 4 by closely contacting the sealant to the same, thereby forming the first and second substrates 2 and 4 into an integral unit. Once again, process steps are eliminated as the sealant and the spacers are simultaneously bound to the substrates in a single process step. By combining these tasks into a single process step, excessive process steps are eliminated, which greatly reduces manufacturing costs, especially in a high throughput environment.

In one embodiment, a thickness t₁ of the height compensation layers 8c is greater than the largest of the gaps t₂ between the second substrate 4 and the uninstalled spacers 8″ that are present prior to applying the pressure onto the second substrate 4. Thus, it is preferred that t₁>t₂. If the thickness t, of the height compensation layers 8c is 3-15% of the entire height of the spacers 8″, the buffer layers 8b are securely filled in the spaces between the main body sections 8a and the second substrate 4 as in FIG. 10B.

By the operation of the height compensation layers 8b as described above, the spacers 8 all come to have substantially the same height. The height compensation layers 8b also act to secure the spacers 8 to the second substrate 4 such that displacement of the spacers 8 from their intended positions is prevented.

To complete the flat panel display, an exhaust opening (not illustrated) formed in the first substrate 2 is used to exhaust the air from between the first and second substrates 2 and 4. The exhaust opening is then sealed to thereby form the vacuum assembly 6 and complete is the flat panel display 102 as illustrated in FIGS. 2 and 3.

In the flat panel display of the present invention described above, the spacers positioned in the display all come to have substantially the same height by the buffer layers. Accordingly, all the spacers receive substantially the same pressure such that the physical breakdown of the same is prevented, the support ability of the spacers is enhanced, and the gap between the first and second substrates is uniformly maintained to thereby enhance picture quality.

Although embodiments of the present invention have been described in detail hereinabove in connection with certain exemplary embodiments, it should be understood that the invention is not limited to the disclosed exemplary embodiments, but, on the contrary is intended to cover various modifications and/or equivalent arrangements included within the spirit and scope of the present invention, as defined in the appended claims.

1. A flat panel display, comprising:
a vacuum assembly comprising a first substrate and a second substrate provided opposing one another with a predetermined gap therebetween, a vacuum state being maintained between the first and second substrates; and
a plurality of spacers mounted between the first substrate and the second substrate, wherein each of the plurality of spacers comprises a main body section, and a buffer layer mounted on one end of each main body section and filling a space between this end of the main body section and one of the first substrate and the second substrate.

2. The flat panel display of claim 1, wherein a thickness of each buffer layer varies between different ones of said plurality of spacers.

3. The flat panel display of claim 1, wherein a sum of a length of a main body section and a buffer layer being substantially equal for each of said plurality of spacers.

4. The flat panel display of claim 1, wherein a cross sectional size and a cross sectional shape of a buffer layer being substantially equal to a cross sectional size and a cross sectional shape of each main body section, where the cross sections are taken along planes substantially parallel to the first and second substrates.

5. The flat panel display of claim 1, wherein the flat panel display is a field emission display, the field emission display comprises:
cathode electrodes and gate electrodes formed on the first substrate with an insulation layer interposed therebetween;
electron emission sources formed on the cathode electrodes;
an anode electrode formed on the second substrate; and
phosphor layers positioned on one surface of the anode electrode.

6. The flat panel display of claim 1, the buffer material being made out of a different material than the main body section.

7. A method for manufacturing spacers, comprising:
printing a photosensitive paste on a substrate;
drying the paste to form a base layer;
positioning the main body sections on the base layer;
exposing the base layer with the main body sections thereon, said main body sections serving as a mask to the portions of the base layer underneath the main body sections;
developing the substrate to remove exposed areas of the base layer and leaving only portions of the base layer directly underneath the main body sections; and
removing the main body sections with remaining areas of the base layer attached thereto from the substrate.

8. The method of claim 7, wherein a thickness of the base layer is 3˜15% of an entire height of the spacers.

9. The method of claim 7, further comprising forming a lift-off metal layer over an entire surface of the substrate prior to printing a photosensitive paste on a substrate.

10. The method of claim 9, further comprising performing wet etching of the lift-off metal layer following developing the substrate in order to remove the main body sections with the base layer attached from the substrate.

11. A method of manufacturing a flat panel display, comprising:
forming structures on a first substrate and a second substrate for realizing the display of images;
producing spacers where each spacer comprises a main body section and a height compensation layer formed at one end of the main body section;
positioning the spacers on the first substrate in predetermined non-pixel regions of the first substrate;
positioning the first substrate and the second substrate in a state opposing one another with the spacers interposed therebetween; and
applying pressure on the second substrate in a direction toward the first substrate to seal the first substrate to the second substrate, and, simultaneously, performing sintering such that the height compensation layers are melted so that any gaps between the spacers and the second substrate are filled by the height compensation layers.

12. The method of claim 11, wherein a thickness of the height compensation layers is 3-15% of an entire height of the spacers.

13. The method of claim 11, wherein said producing spacers comprises:
producing main body sections;
printing a photosensitive paste on a substrate;
drying the paste to form a base layer that is comprised of the same material as said height compensation layers;
positioning the main body sections on the base layer;
exposing the base layer masked by the main body sections so that all areas of the base layer except areas covered by the main body sections are exposed;
developing the base layer to remove all exposed portions of the base layer;
removing the main body sections with remaining areas of the base layer attached thereto from the substrate.

14. The method of claim 13, further comprising forming a lift-off metal layer over an entire surface of the substrate prior to printing a photosensitive paste on a substrate.

15. The method of claim 14, further comprising performing wet etching of the lift-off metal layer following developing the substrate and prior to removing the main body sections.

16. The method of claim 11, wherein an end of the spacer that does not have a height compensation layer is attached to the first substrate.
